(19) United States
(12) Patent Application Publication
(10) Pub. No.: US 2008/0313091 A1
(43) Pub. Date: Dec. 18, 2008

(54) METHOD AND ELECTRONIC PLATFORM FOR ENABLING AND HOSTING A MARKET FOR RESEARCH, AND A TAXONOMY METHOD FOR SPECIFYING RESEARCH

(75) Inventors: William Goodman Russell-Smith, Cheltenham (GB); Albert Domingo Reloj Alonzo, Burton Park (GB); Conchur Dickinson, London (GB)

Correspondence Address: LACKENBACH SIEGEL, LLP, LACKENBACH SIEGEL BUILDING, 1 CHASE ROAD, SCARSDALE, NY, 10583, US

(73) Assignee: AQ Research Ltd., London (GB)

(21) Appl. No.: 12/139,951

(22) Filed: Jun. 16, 2008

Related U.S. Application Data
(60) Provisional application No. 60/944,092, filed on Jun. 14, 2007.

(51) Int. Cl. G06Q 30/00; G06Q 50/00

(52) U.S. Cl. 705/80

(57) ABSTRACT

An operational method and an electronic market platform for hosting a market place for investment research products that have been classified according to a species of research based upon a buyer-side ex-ante procurement process. Research providers are able to provide a range of prices for each species or class of equity research service provided and fund managers (research consumers) are able to place purchaser orders via the electronic market platform in a desired range according to a relative negotiating position. A research procurement “hub” enables fund managers (research consumers) to consolidate their purchases for internal and external negotiations based upon and subject to market forces.

### RELATED APPLICATIONS

This application claims the priority benefit of U.S. Provisional Application No. 60/944,092 filed on Jun. 14, 2007, which provisional application is hereby incorporated by reference in its entirety as if fully set forth herein.

### BACKGROUND OF THE INVENTION

1. Field of the Invention

The present invention relates to a hosted market place for unbundled investment research products according to a determined taxonomy. More specifically, the present invention relates to a web-based platform enabling such a market using networked computers.

2. Description of the Related Art

There has been recent development of a need for the efficient delivery of unbundled investment and financial research (as contrasted with the research of integrated investment firms that include both investment services and investment research). This unbundling has had and will have a major impact upon the market for investment research services.

The emerging market for investment research products is unique and different from the market for other services in many ways. Thus, an electronic platform for enabling and hosting such a market should be correspondingly different from the market platform used for other services. In order to understand such differences, the background of investment research products will be discussed.

In integrated investment firms, corporate finance operations subsidize research analysts who, in return, are at least perceived to give the bank's or fund's corporate clients recommendations that are generally regarded as being better than the recommendations of others. One critical problem is that research in an integrated investment firm relies essentially on a subsidy from the rest of the firm, and the other part of the firm that benefits is corporate finance. Variable or poor quality sell-side research products often consist of one-size-fits-all reports lacking in essential detail. For example, research products on small and midsize capitalization stocks may currently suffer from poor quality, but research products on large capitalization stocks do not. The measurable benefits of unbundling are not, on their own, compelling. Institutions prefer, through bundling, to get a sub-standard product free.

The variable or poor quality of investment research products from the “sell-side” of integrated investment firms is thus challenging the development of an efficient market. But integrated investment firms do not loudly complain because they essentially get this research for free. Instead, integrated investment firms have learned to get brokers to bundle research costs with execution costs for an increased all-in fee and then pass the entire cost off. If fund managers complained too loudly about research quality, they would draw attention to their own sleight of hand and find their trustees defining their research costs, more properly, as part of the management charge.

The more or less traditional model was broadly known for the process for deciding upon research payments in an integrated house that occur as follows: (1) a fund manager would determine a desired total sum to be allocated in total commission which seems largely grounded on historic payments. This commission was split between research and execution by comparing bundled rates offered by brokers with execution only rates to give a percentage split applied to the total. The research commissioners would (2) divide this commission bundled payment between investment teams according to some internal mandate and the teams then vote on the brokers. This type of series-allocation is calculated to give brokers their research commission with feedback on their past performance.

Thus there is a strange but persistent inefficiency in the market for investment research services—lack of an efficient process for explicitly pricing research services. Accordingly, what is not appreciated in the related art, is that the market for investment research products needs to be able to break free of the traditional constraints on such a market as described above. In particular, the investment research products must be made available in a manner that accounts for quality and other factors of the research to the satisfaction of the market participants.

Quite apparently, it would be helpful if there were an electronic marketplace that was available for investment research products. Attempts to do so have been made. For example, it is possible to identify and obtain investment research products using the website at www.markets.com. However, the website is scarcely much different that the standard website for obtaining other kinds of services, and fails to meets the peculiar needs of the market for investment research services.

What is not appreciated is the need for a business method that supports such an electronic marketplace in a stable, accessible and reviewable or auditable manner. What is further needed is a reliable way in which to specify common species and types of research so that providers of similar species and types of research may compete in a supported electronic marketplace based upon price, thereby generating a form of “menu pricing” allowing research consumers to choose providers of similar species of research having similar quality based upon price.

### BRIEF SUMMARY

A main objective of the preferred embodiments of the invention is to enable an electronic market platform that assists the investment community in establishing and hosting a market for investment research and its explicit pricing. In large part, the market place supports a methodology and a taxonomy applied to different types of investment research to operate as a bridge between research providers (e.g. brokers) and the research consumers (e.g. fund managers). The marketplace enables providers and purchasers of investment research products to define capabilities/needs and negotiate on explicit pricing across the whole range of research services. This marketplace in turn improves the efficiency of research services market.

Another object of the preferred embodiments is to enable research providers in a hosted market place to give a range of prices for each of a common species or type of research, and for fund managers to place purchase orders for such desired types of research within a selected range of prices according to the relative negotiating position between provider and consumer.

Another object of the preferred embodiments is to provide, for a investment research consumer, a way in which purchases of such research services may be consolidated at a research procurement hub allowing both internal and external negotiation. Such a research procurement hub allows a centralized function at a fund manager's location to oversee the research that individual users are requesting and to adjust accordingly.

Another objective of the present invention is to provide a method and system that enhances a quality of research procurement negotiations.

Another object of the present invention is to provide a plurality of broker/seller offer screens for inputting equity research products as research offers linked to listings of research providers and a plurality of purchasing and selecting screens allowing fund managers to review proposed classified offers for equity research services.

The present invention provides operational method and an electronic market platform for hosting a market place for investment research products that have been classified according to a species of research based upon a buyer-side ex-ante procurement process. Research providers are able to provide a range of prices for each species of classified research and research consumers (e.g. fund managers) are able to place purchaser orders via the electronic market platform in a desired range according to a relative negotiating position. A research procurement “hub” enables research consumers (e.g. find managers) to consolidate their purchases for internal and external negotiation based upon market forces.

The present invention provides an operational electronic system and market platform for hosting a market exchanging research products between research providers (e.g. brokers) and research consumers (e.g. fund managers), said system and marked platform comprising: means for suppliers of research products to input a plurality of research products into a purchaser-available interface; taxonomy means for classifying said plurality of research products according to one of a type and a valuation of said research product; hosting means for presenting said plurality of research products identified according to said respective one of said type and said valuation of said research product following an operation of said taxonomy means; assembling means for assembling and presenting said plurality of identified research products from a plurality of suppliers of research products as a series of offers available for acceptance to form a binding contract; interaction means for enabling respective said suppliers to consider said series of offers available for acceptance and for selecting and accepting designated ones of said offers; whereby said binding contract is formed establishing said market exchange.

The present invention further provides an operational electronic system, wherein: said taxonomy means for classifying a said research products according to said one of said one of said type and said valuation further includes means for means for classifying said type of research into at least one of a class comprising: a top idea class, a report set class, an analyst access class, a projects class, a company meetings class, a conferences class, and an analysis tools class.

The present invention further provides an operational electronic system, wherein: said one of a type and a valuation of said research product includes a discrete, structured, comparable unit of service that said research providers (e.g. brokers) commits to deliver to said fund research consumers (e.g. fund managers), during the course of a predetermined time.

The present invention also provides a web-based interactive platform for providers of research services to display their range of services and prices and for portfolio managers to select and contract the level of research service required.

The above, and other objectives, features and advantages of the preferred embodiments of the present invention will become apparent from the following description read in conduction with the accompanying drawings, in which like reference numerals designate the same elements.

### BRIEF DESCRIPTION OF THE DRAWINGS

FIG. 1 is a conceptual illustration of the web-based electronic platform for investment research products, arranged about a central database according to a preferred embodiment of the invention.

FIG. 2 is an overview of the process implemented by the web-based electronic platform according to a preferred embodiment of the invention.

FIG. 3 illustrates the Model Research Usage process 1 in the preferred embodiment of the invention shown in FIG. 2.

FIG. 4 illustrates the Define Services Offered process 2 in the preferred embodiment of the invention shown in FIG. 2.

FIG. 5 illustrates the View Offers process 3 in the preferred embodiment of the invention shown in FIG. 2.

FIG. 6 illustrates the Provider's View Demand process 4 in the preferred embodiment of the invention shown in FIG. 2.

FIG. 7 illustrates the Manage Bids process 5 in the preferred embodiment of the invention shown in FIG. 2.

FIG. 8 illustrates the Allocate Services process 6 in the preferred embodiment of the invention shown in FIG. 2.

FIGS. 9-14 are various input screens of the web-based electronic platform according to a preferred embodiment of the invention.

### DETAILED DESCRIPTION OF THE PREFERRED EMBODIMENTS

Reference will now be made in detail to several preferred embodiments of the invention that are illustrated in the accompanying drawings. Wherever possible, the same or similar reference numerals are used in the drawings and the description to refer to the same or like parts or steps. The drawings are in simplified form and are not to precise scale. For purposes of convenience and clarity only those of skill in the art will recognize that directional terms, such as top, bottom, up, down, over, above, and below may be used with respect to the drawings. These and similar directional terms should not be construed to limit the scope of the invention in any manner.

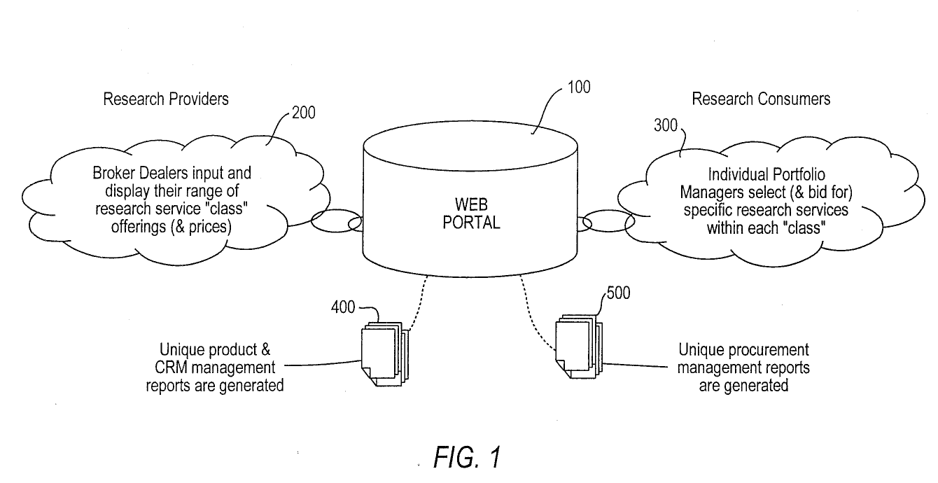

Referring now to FIG. 1, the electronic web-based platform of the preferred embodiment is conceptually represented. At the center is the hosted web portal 100 which may be accessed by both the providers 200 of investment research products and the consumers 300 of investment research products. Providers 200 input and display their range of research service “class” offerings. They may also optionally provide prices for their research products. Each one of providers 200 can, upon request, generate and receive product and customer relationship management (CRM) reports 400 to gauge and improve their success in the marketplace. Consumers 300, such as individual portfolio managers, select specific research services from within each “class.” The consumers 300 may purchase the research services at prices set by a provider 200 or may bid for the research services. Consumers 300 can, upon request at the web portal, generate and obtain a procurement management report.

The web portal 100 includes a comprehensive catalog of research services as well as various indicators of market demand. It provides an unbiased level market for buying and selling investment research services. There are preferably searchable profiles so that participants on both sides of the transactions can interact directly with each other with knowledge.

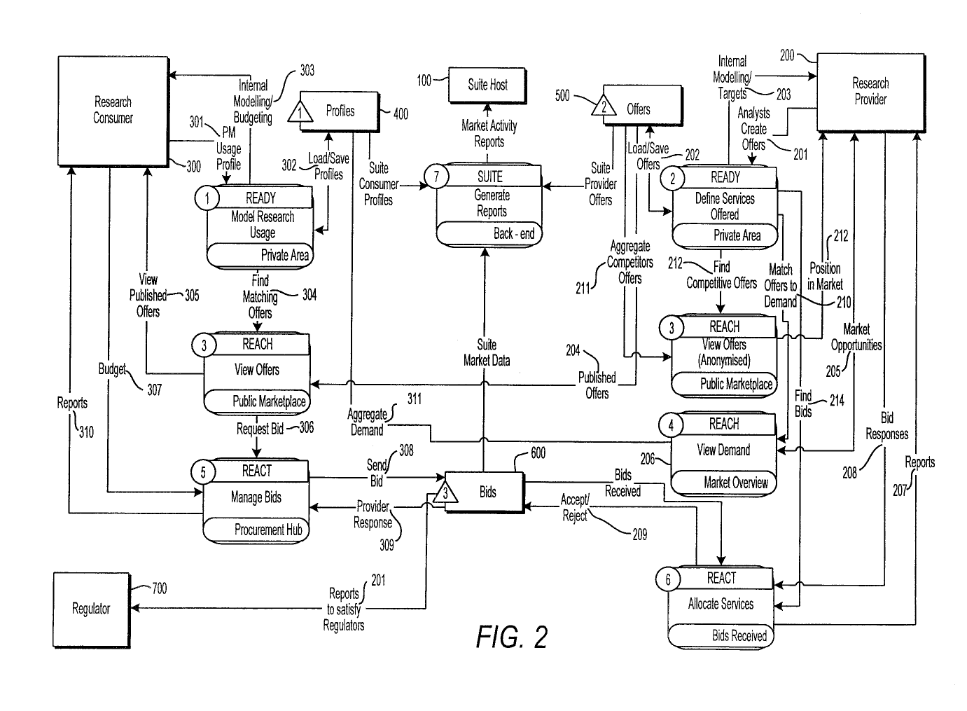

FIG. 2 shows an overview of the process performed by Host 100, Research Consumer 300 and Research Provider 200. Although only one Research Consumer 300 and one Research Provider 200 is shown, there are in fact a plurality of consumers and providers participating in the web portal. There may also be a Regulator 700 which receives reports 701 on bids in Bids database 600. Although Profiles database 400, Offers database 500 and Bids database 600 are shown separately, the information may in fact be stored in a single relational database. There are generally three stages of a successful transaction indicated in the drawings as “Ready”, “Reach” and “React” and discussed in detail below.

A consumer 300 can create a usage profile 301 using the Model Research Usage process 1 of the portal, which profile is then loaded/saved 302 in Profiles database 400. The profiles of consumers 300 are aggregated to determine cumulative demand, which is provided to View Demand process 4 so that market opportunities 205 can be indicated to research provider 200 by matching offers from Define Services Offered process 2 to the demand 210. Consumer 300 can also utilize the Model Research Usage process 1 to engage in internal modeling/budgeting 303. Conversely, Research Provider 200 can create offers 201 using the Define Services Offered process 2 of the web portal, which offers are then loaded/saved 502 in Offers database 500. Research Provider 200 can also utilize the Define Services Offered process 2 to engage in internal modeling/budgeting 203.

Consumer 300 can use its profile to find matching offers 304, and view published offers 305 using the View Offers process 3. The offers are the published offers 204 obtained from Offers loaded/saved in database 500. Consumer 300 can then request a bid 306, which is managed in accordance with the budget 307 using the Manage Bids process 5. If appropriate, a bid is sent 308 to Bids database 600, The bids are received 206 by the Allocate Services process 6, which makes reports 207 to research provider 200. Bid responses 208 are returned by research provider 200 to Allocate Services process 6, which also receives bids found 214 by Define Services Offered process 3. An accept/reject response 209 is sent for each of the bids to Bids database 600. The provider's accept/reject response is forwarded 309 to Manage Bids process 5 for consumer 300 and reports 310 are provided to research consumer 300.

Research provider 200 can find competitive offers 212 using Define Services Offered process 2. When considered along with an aggregate of the competitors' offers 211 in Offers database 500, Research Provider 200 can utilize an anonymized View Offers process 3 to obtain information indicating its position in the market 213. Other market information consists of the consumer profiles, provider offers and market data sent to the Generate reports process 7 of the web portal, which provides market activity reports to the web portal host 100.

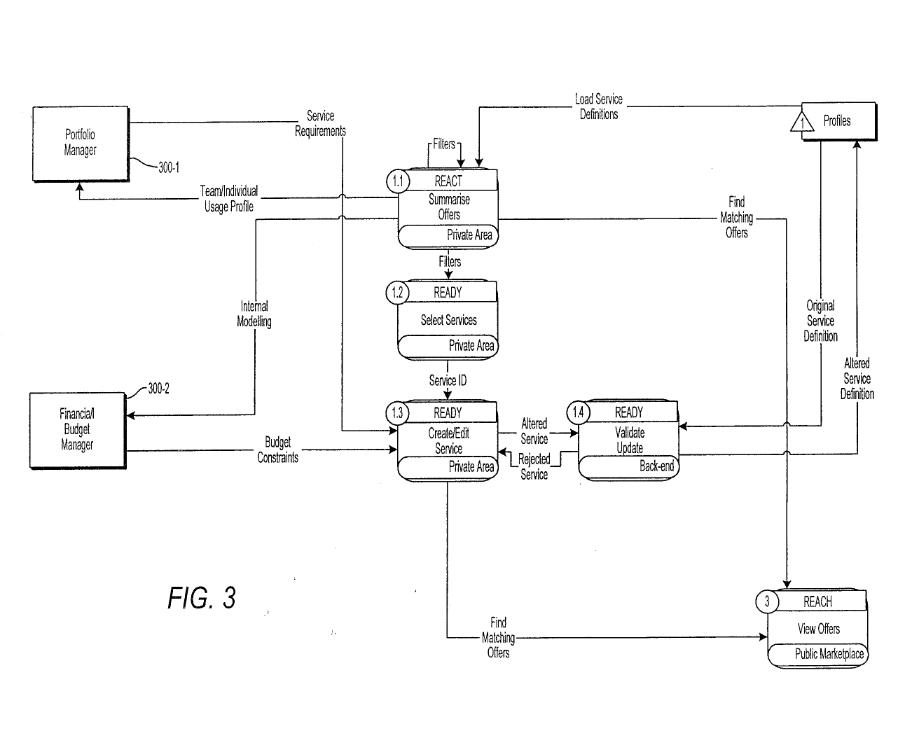

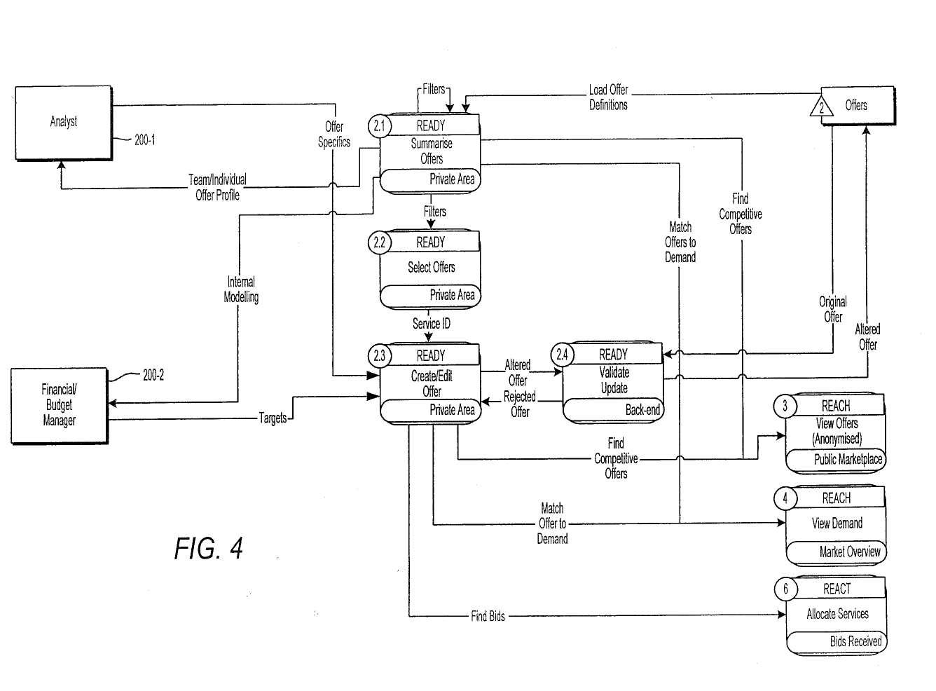

FIGS. 3-8 are directed to respective processes, and show various details of each of the processes, much of which is the same as shown in FIG. 2. In FIG. 3, it is shown that the Model Research Usage process 1 accommodates both a Portfolio Manager 300-1 and a Financial/Budget Manager 302 of Research Consumer 300. The profiles can thus be filtered, validated and altered. Thus, the offers can be matched to the budget constraints as well as the profile. In FIG. 4, it is shown that the Define Services Offered process 2 can include both an Analyst 200-1 and a Financial/Budget Manager 200-2. The offers can be filtered, validated and altered accordingly. The competitive offers that are found and the matching of offers to demand can be matched to the targets set by Financial/Budget Manager 200-1. This enables the research provider 200 to maximize its reach and economic returns for its services.

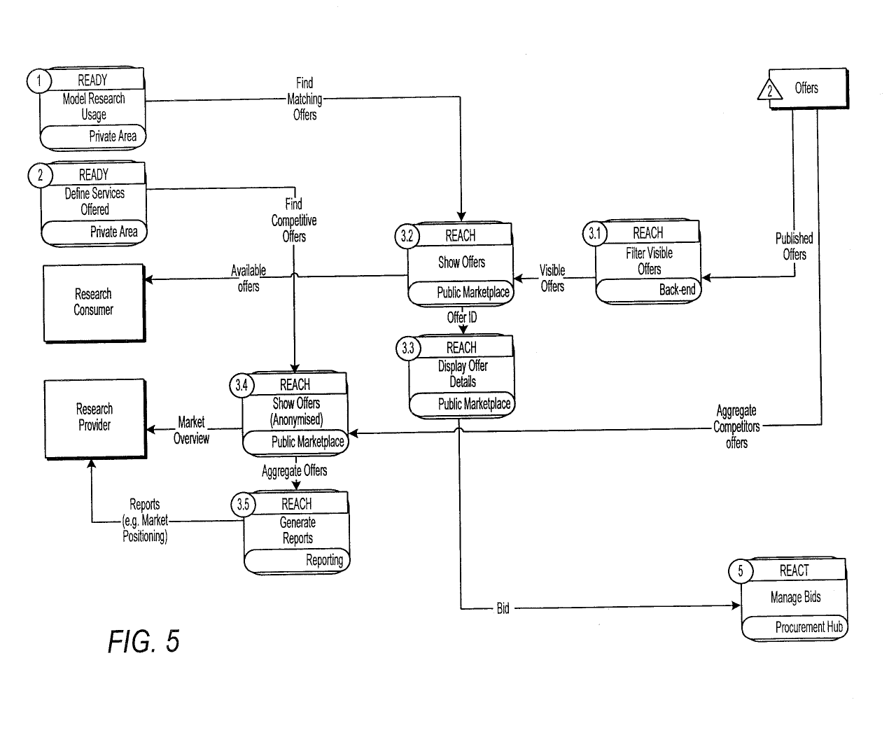

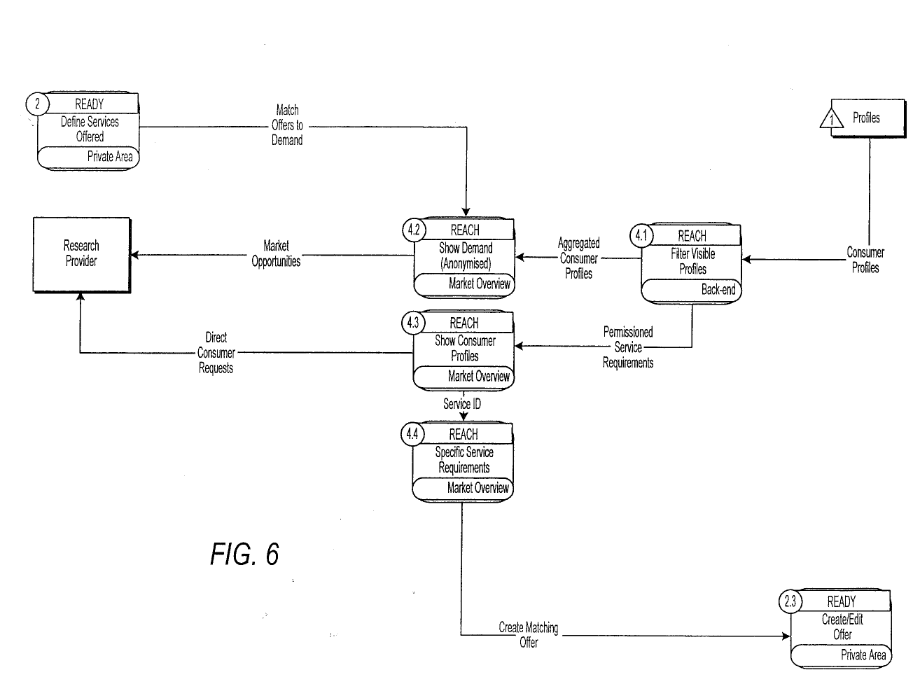

In FIG. 5, the details of the respective View Offers process 3 are shown. The published offers 204 from Offers database 200 may be filtered to limit the offers made visible and available to research consumer 300. In FIG. 6, the details of the respective View Demand process 4 are shown. The consumer profiles used to determine aggregate demand may be filtered. Additionally, permissioned service requirements may be utilized to selectively show individual consumer profiles and receive direct consumer requests. A research consumer 300 preferably has the ability to decide whether or not its requirements are made known in a manner that is either pseudoanonymous (using a Service ID to identify itself) or entirely open to the research providers. For a consumer 300 who has granted such permission, research provider 200 may create and edit an offer that matches the consumer's profile.

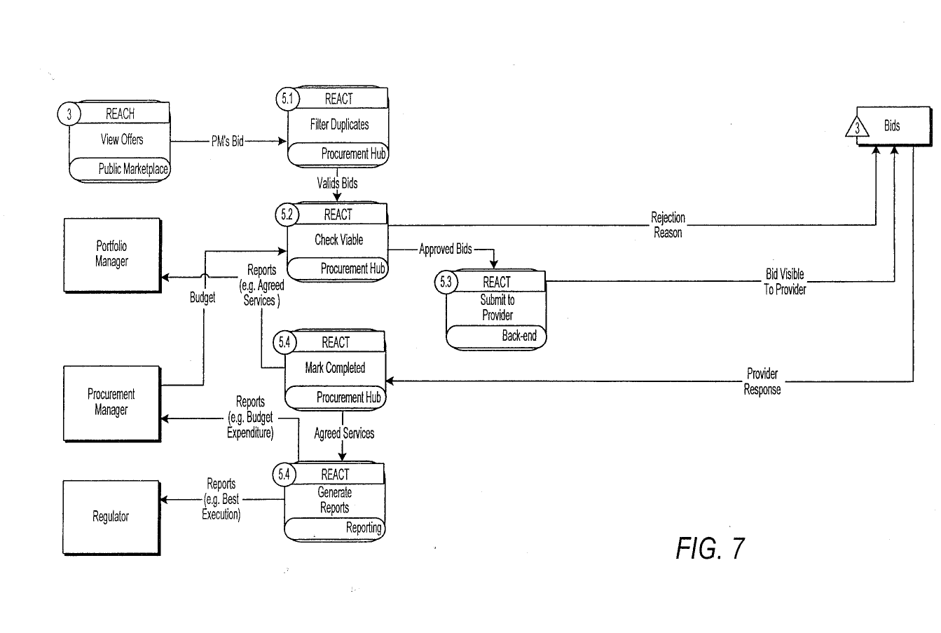

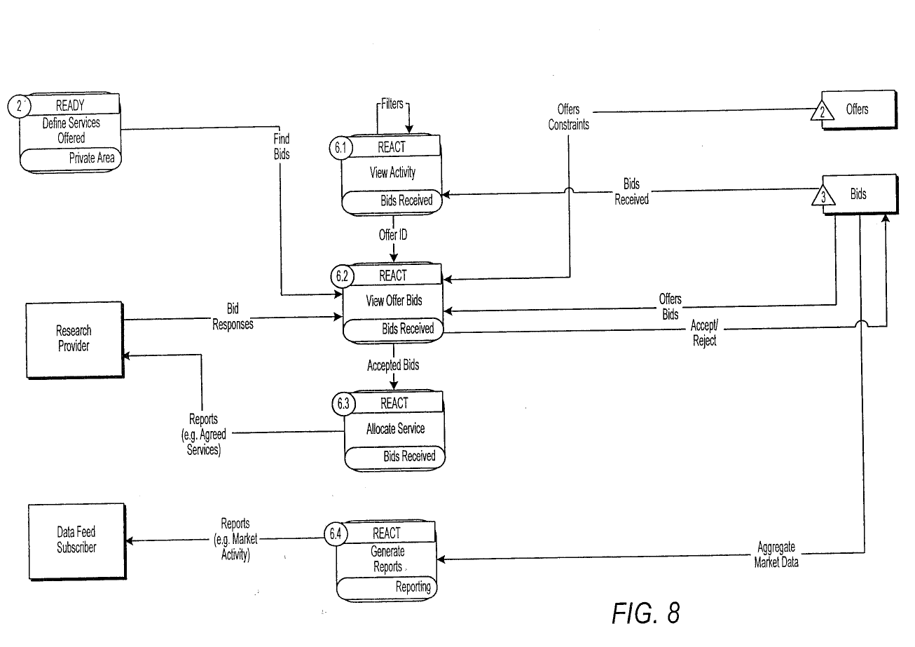

In FIG. 7, the details of the Manage Bids process 5 is shown. It shows that the bid of a portfolio manager 300-1 may be filtered (preferably automatically) to determine if it is a duplicate of another bid and only after it is checked to be sure it is viable, is it then approved to be submitted to the provider. Furthermore, the reports to research consumer 300 may consist of several different reports reflecting the different roles and levels of permissions of a portfolio manager 300-1 and a procurement manage 300-2. In FIG. 8, the details of the Allocate Services process 6 is shown. The offers in Offers database 500 may have permissioning constraints where the research provider has the ability to decide whether or not one of its offers may be made known and offered to a research consumer 300. Furthermore, aggregate market data from the bids database 600 may be included in a report on market activity to a data feed subscriber.

Beyond the methodology shown in FIGS. 2-8, an important aspect of the preferred embodiments is found in the manner of presentation and manipulation of information related to research offers and bids on the web portal 100. In particular, there is preferably a taxonomy capability, or ability to divide the total types of investment research into seven (7) typical classes of research products, allowing like-for-like comparisons between services from different research providers 200. These eight classes of research include, but are not limited to: top ideas, report sets, analyst access, projects, company meetings, conferences, and analysis tools. This classification differentiates research so that the services can be better evaluated. The alternative and additional classes of research may be made according to any suitable taxonomy of types of equity research services known to those of skill in the art. Preferably, a “class” of equity research service can be described a discrete, structured, comparable unit of service that a broker/IP commits to deliver to an individual portfolio manager in the course of a time period—commonly 12 months.

Additional details help target the service and increase its relevance to consumers. These details include stocks covered, resources allocated, and supply constraints. Indications of interest and transactions based on such well-defined research services can provide rich feedback on demand and trends for specific areas.

Based upon the present disclosure, those of skill in the electronic arts will recognize that the web portal as described herein can be easily implemented to be accessable by a large number of market participants over the Internet or other wide area network using a standard web browser with appropriate security control and access monitoring features. In particular, the web portal can be implemented on a web server utilizing well known Web Services and related technologies without the need for any browser plug-in or other software to be installed on the computers of market participants. Indeed, the web portal can be implemented using standard server and related hardware. There may be software provided on a recording medium, such as an optical disk, which when executed by the server and related hardware causes it to provide and operate the web portal as described herein.

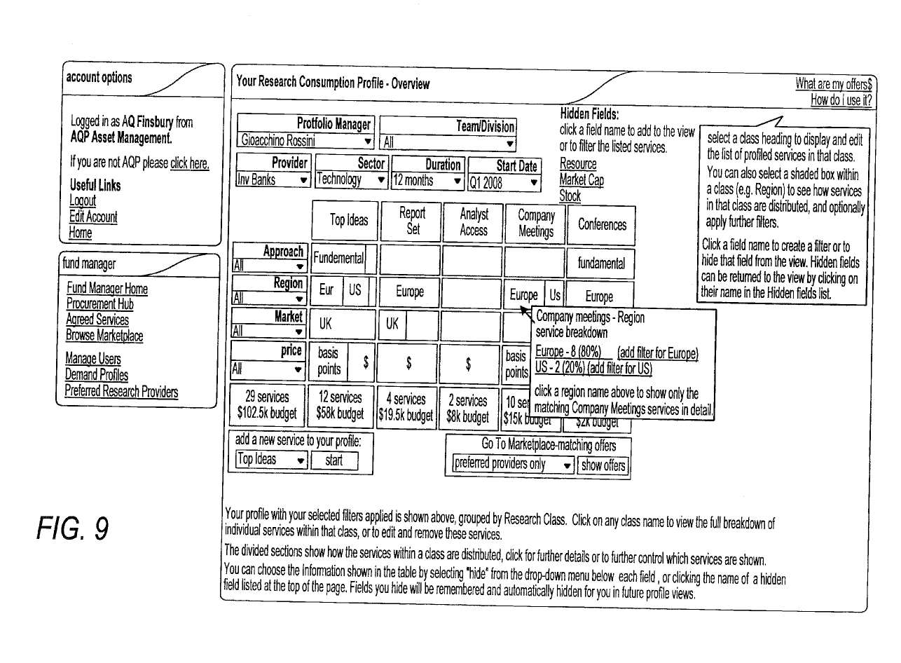

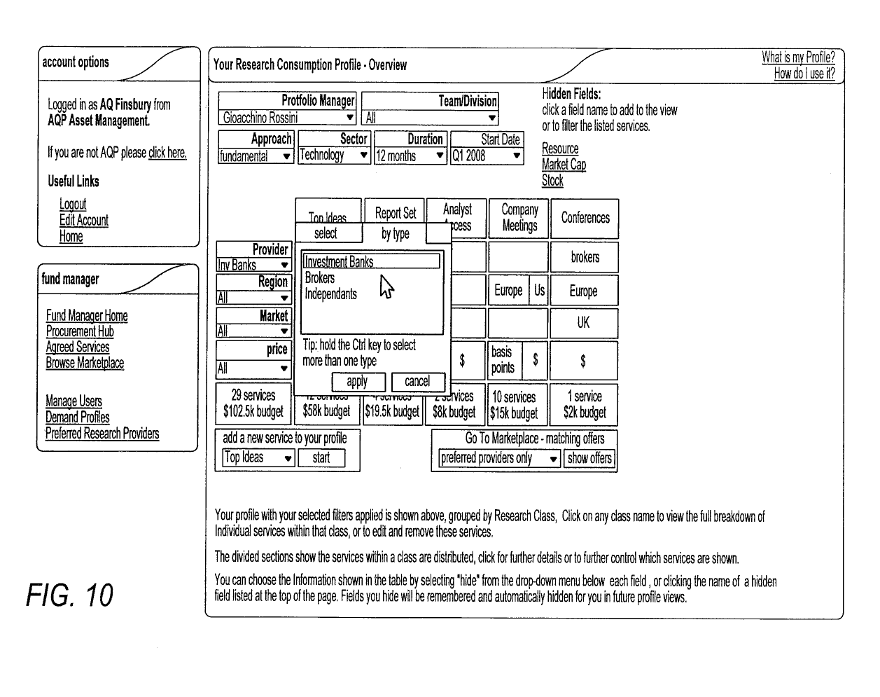

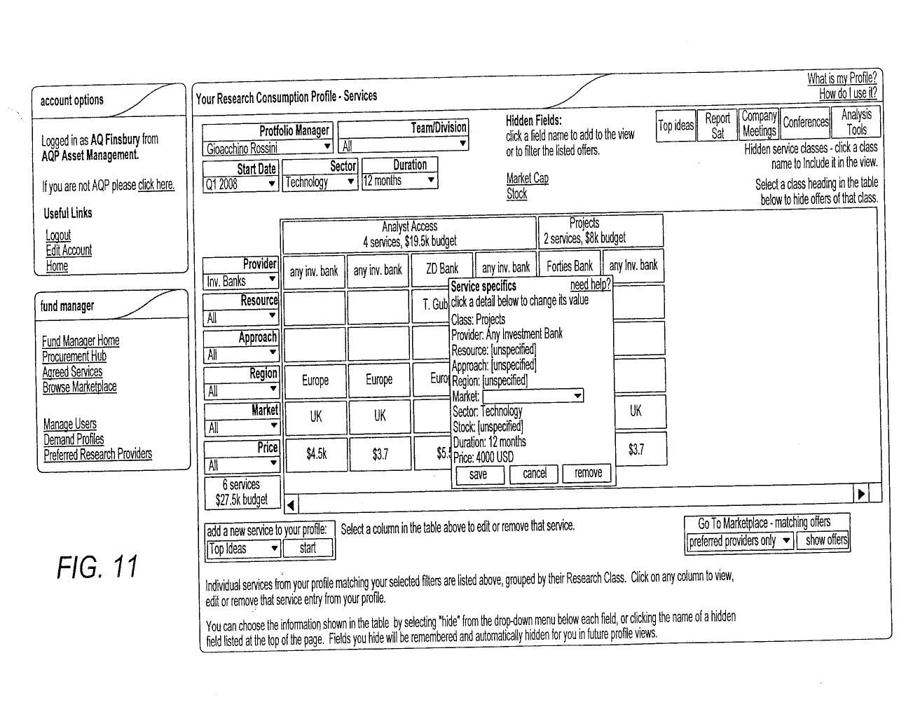

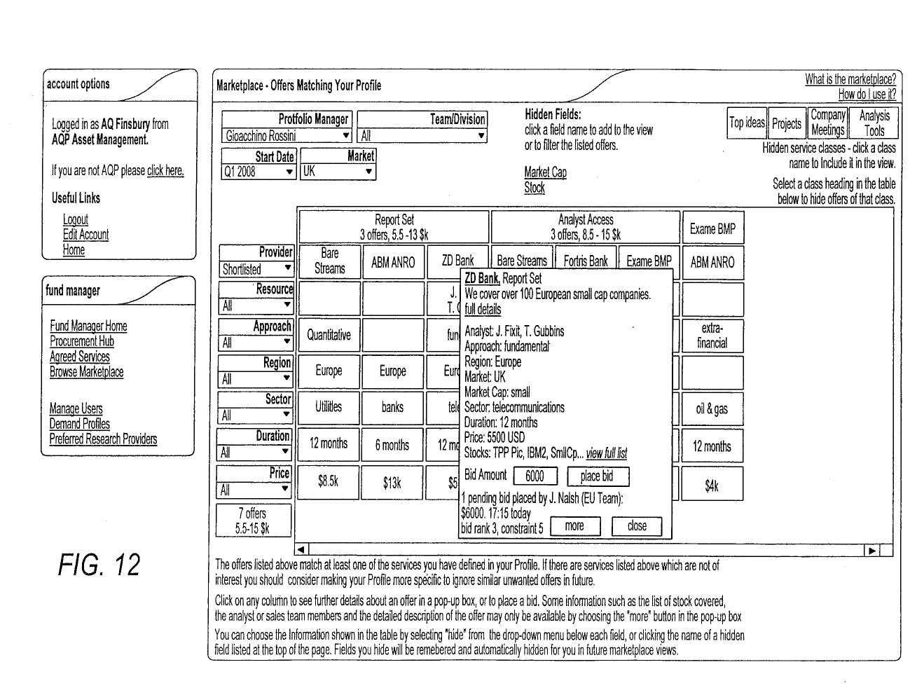

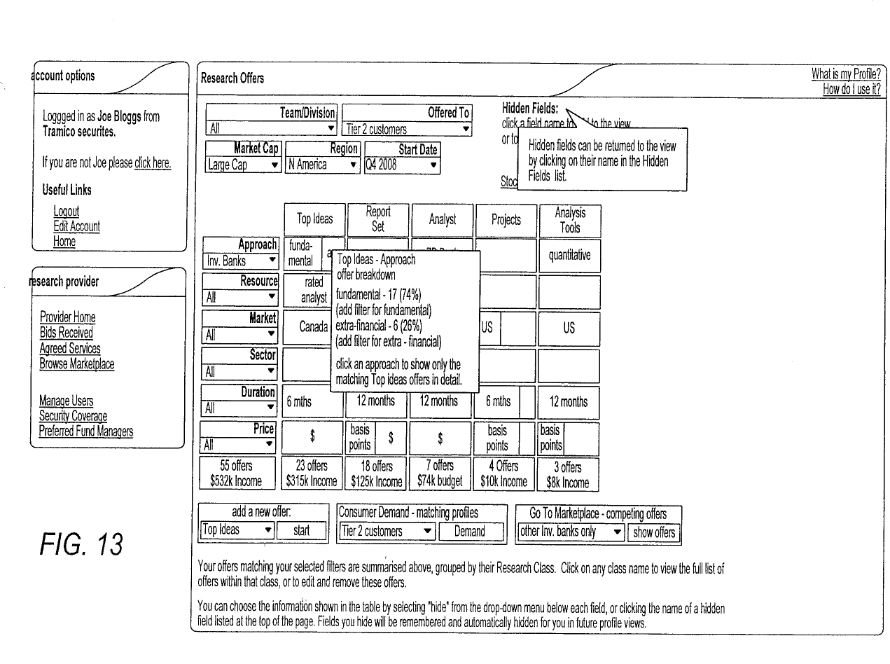

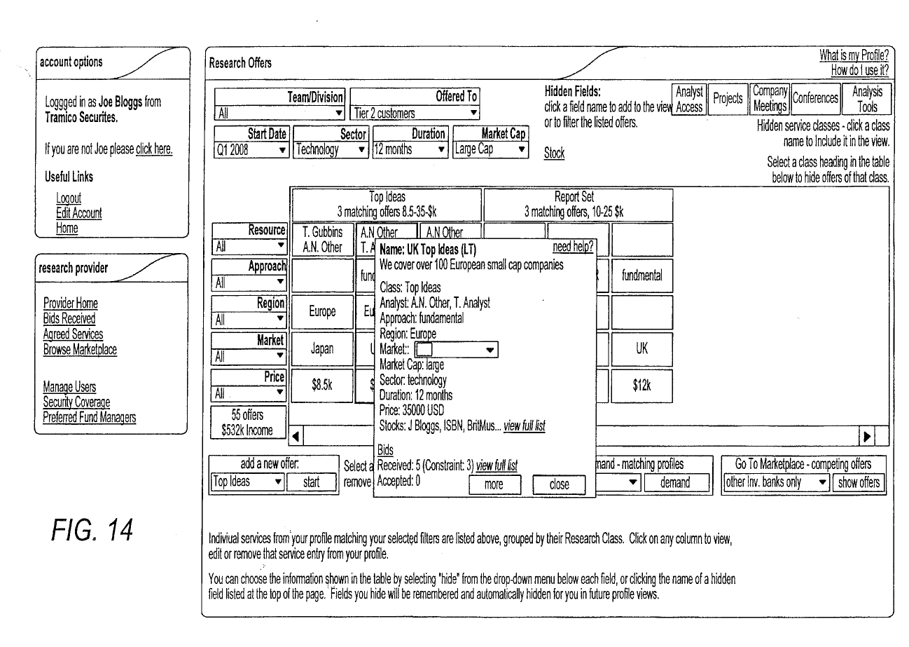

There are of course user interactions supported by the web portal, which consists primarily of different screens and views for the different operations described above. FIGS. 9-14 show examples of different screens that may be made available to research consumers and providers in a preferred embodiment of the invention. FIG. 9 shows the Profile Summary of a research consumer. FIG. 10 shows how the Profile Summary can be filtered, such as by type. FIG. 11 shows a screen on which the research consumer can view and edit the details of their service specifics. FIG. 12 shows a screen in which the marketplace of offers is filtered by the profile of the research consumer to identify offers matching their profile. FIGS. 13 and 14 show examples of screens presented to a research provider. FIG. 13 is a screen shown to provide a summary of research offers. FIG. 14 is a screen shown to provide a detailed offers view including the details of research offers. Of course, these screens are merely exemplary and different screens may be utilized in other embodiments of the invention.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of providing an electronic platform for hosting a market exchanging research products between providers and consumers, said method comprising:
supplying offers of a plurality of research products into a web-based interface;
classifying said plurality of research products according to one of a type and a valuation of said research product;
presenting said plurality of research products identified according to said respective one of said type and said valuation of said research product following said classifying;
assembling and presenting said plurality of identified research products from a plurality of providers of research products as a series of offers available for acceptance; and
enabling respective said suppliers to consider said series of offers available for acceptance and for selecting and accepting designated ones of said offers.

2. A method according to claim 1, wherein:
said classifying of said research products according to said one of said one of said type and said valuation includes a taxonomy for classifying said type of research into at least one of a class comprising: a top idea class, a report set class, an analyst access class, a projects class, a company meetings class, a conferences class, and an analysis tools class.

3. A method according to claim 1, wherein:
said one of a type and a valuation of said research product includes a discrete, structured, comparable unit of service that said provider commits to deliver to said consumer.

4. A method according to claim 1, wherein each consumer may create a profile.

5. A method according to claim 4, wherein said profile is utilized to find matching offers of a plurality of research products.

6. A method according to claim 5, wherein said matching offers are filtered according to budget constraints created by the consumer.

7. A method according to claim 1, wherein said provider may identify competitive offers and receive an anonymized aggregate of the competitors' offers.

8. A method according to claim 7, wherein the electronic platform provides an indication of the provider's position in the market.

9. A method according to claim 7, wherein the providers may match their offers to market demand.

10. An electronic platform operating on a network server and hosting a market exchanging research products between providers and consumers, said electronic platform carrying out operations comprising:
supplying offers of a plurality of research products into a web-based interface;
classifying said plurality of research products according to one of a type and a valuation of said research product;
presenting said plurality of research products identified according to said respective one of said type and said valuation of said research product following said classifying;
assembling and presenting said plurality of identified research products from a plurality of providers of research products as a series of offers available for acceptance; and
enabling respective said suppliers to consider said series of offers available for acceptance and for selecting and accepting designated ones of said offers.

11. An electronic platform according to claim 10, wherein:
said classifying of said research products according to said one of said one of said type and said valuation includes a taxonomy for classifying said type of research into at least one of a class comprising: a top idea class, a report set class, an analyst access class, a projects class, a company meetings class, a conferences class, and an analysis tools class.

12. An electronic platform according to claim 11, wherein:
said one of a type and a valuation of said research product includes a discrete, structured, comparable unit of service that said provider commits to deliver to said consumer.

13. An electronic platform according to claim 10, wherein each consumer may create a profile.

14. An electronic platform according to claim 13, wherein said profile is utilized to find matching offers of a plurality of research products.

15. An electronic platform according to claim 14, wherein said matching offers are filtered according to budget constraints created by the consumer.

16. An electronic platform according to claim 10, wherein said provider may identify competitive offers and receive an anonymized aggregate of the competitors' offers.

17. An electronic platform according to claim 16, wherein the electronic platform provides an indication of the provider's position in the market.

18. An electronic platform according to claim 16, wherein the providers may match their offers to market demand.

19. A software program, recorded on a tangible medium, when executed by a computer causing the computer to carry out a method of providing an electronic platform for hosting a market exchanging research products between providers and consumers, said method comprising:
supplying offers of a plurality of research products into a web-based interface;
classifying said plurality of research products according to one of a type and a valuation of said research product;
presenting said plurality of research products identified according to said respective one of said type and said valuation of said research product following said classifying;
assembling and presenting said plurality of identified research products from a plurality of providers of research products as a series of offers available for acceptance; and
enabling respective said suppliers to consider said series of offers available for acceptance and for selecting and accepting designated ones of said offers.

20. A software program according to claim 19, wherein:
said classifying of said research products according to said one of said one of said type and said valuation includes a taxonomy for classifying said type of research into at least one of a class comprising: a top idea class, a report set class, an analyst access class, a projects class, a company meetings class, a conferences class, and an analysis tools class.

21. A software program according to claim 19, wherein:
said one of a type and a valuation of said research product includes a discrete, structured, comparable unit of service that said provider commits to deliver to said consumer.

22. A software program according to claim 19, wherein each consumer may create a profile.

23. A software program according to claim 22, wherein said profile is utilized to find matching offers of a plurality of research products.

24. A software program according to claim 23, wherein said matching offers are filtered according to budget constraints created by the consumer.

25. A software program according to claim 19, wherein said provider may identify competitive offers and receive an anonymized aggregate of the competitors' offers.

26. A software program according to claim 25, wherein the electronic platform provides an indication of the provider's position in the market.

27. A software program according to claim 25, wherein the providers may match their offers to market demand.
